(19) United States
(12) Patent Application Publication
(10) Pub. No.: US 2026/0135332 A1
(43) Pub. Date: May 14, 2026

(54) LEVER-OPERATED CONNECTOR

(71) Applicant: Yazaki Corporation, Tokyo (JP)

(72) Inventors: Shiori TSUCHIYA, Makinohara-shi (JP); Fumiya Kojima, Tokyo (JP)

(73) Assignee: Yazaki Corporation, Tokyo (JP)

(21) Appl. No.: 19/381,091

(22) Filed: Nov. 6, 2025

(30) Foreign Application Priority Data
Nov. 12, 2024 (JP) 2024-197434

(51) Int. Cl. H01R 13/629; H01R 13/506; H01R 13/627

(52) U.S. Cl. CPC H01R 13/62938; H01R 13/506; H01R 13/6275; H01R 13/62977

(57) ABSTRACT

A lever-operated connector includes: a housing; a holder accommodating the housing; and a lever pivotably mounted to the housing and configured to be rotated by the housing, wherein the lever includes: a lever main body having a plate shape and insertable between the housing and the holder; a lock arm provided at the lever main body to be lockable to an end edge of the holder; and a displacement limiting section configured to limit displacement of the lock arm, wherein the lock arm includes: an arm cut out from the lever main body; and a lock protrusion protruding from a free end of the arm to be lockable to the end edge of the holder, wherein the displacement limiting section includes a receiving surface which extends obliquely to protrude closer to the lock arm in a direction of unlocking the lock protrusion from the end edge of the holder.

### BACKGROUND OF THE INVENTION

### Technical Field

The present invention relates to a lever-operated connector.

### Background Art

A lever-operated connector is known which includes a connector main body and a lever, the connector main body holding terminals and the lever being rotatably supported by the connector main body, wherein rotating the lever, a partner connector is moved toward the connector main body to be mated therewith (see e.g. Patent Document 1).

FIG. 9 shows a front view of a conventional lever-operated connector 101. The lever-operated connector 101 includes a connector main body 102 and a lever 103, the connector main body 102 being configured to be mated with a partner connector (now shown), wherein the lever 103 is configured to move the connector main body 102 toward the partner connector as the lever 103 is rotated, whereby the connector main body 102 is mated with the partner connector.

The connector main body 102 includes an inner housing 104 and a front mask 105, the inner housing 104 accommodating a plurality of female terminals, wherein the front mask 105 accommodates the inner housing 104. The lever 103 includes a pair of lateral plates 103A and a connecting plate (not shown) connecting the pair of lateral plates 103A, wherein the inner housing 104 is interposed between the pair of lateral plates 103A and the lever 103 is configured in the form of a gate. Each of the lateral plates 103A of the lever 103 includes a lock arm 103D configured to be locked to an opening inner edge 105a of the front mask 105. Rotation of the lever 103 is limited by locking the lock arm 103D to the opening inner edge 105a of the front mask 105 so that the lever 103 is maintained in an initial position. The lever-operated connector 101 is shipped and transported with the lever 103 being in the initial position.

### Citation List

### Patent Literature

Patent Document 1: JP 2021-125403 A

### SUMMARY OF THE INVENTION

However, in the event of an unintended external force acting on the lever 103 when transporting the conventional lever-operated connector 101, this may result in rotation of the lever 103 which may in turn result in displacement of the lock arm 103D so that an engaged margin k of the lock arm 103D for engagement with the opening inner edge 105a is reduced. This makes it difficult to maintain a state of the lever 103 which is in the initial position.

An objective of the present invention is to provide a lever-operated connector including a lever configured to be brought into an initial position by a lock arm, wherein the lever-operated connector enables an unlocking event of the lock arm to be suppressed in the initial position even when an unintended external force is applied to the lever.

In order to achieve the above-mentioned objective, the invention according to claim 1 provides a lever-operated connector including: a housing; a holder configured to accommodate the housing; and a lever pivotably mounted to the housing and configured to be rotated by the housing, wherein the lever includes: a lever main body having a plate shape and configured to be inserted between the housing and the holder; a lock arm provided at the lever main body to be lockable to an end edge of the holder; and a displacement limiting section configured to limit displacement of the lock arm, wherein the lock arm includes: an arm cut out from the lever main body; and a lock protrusion protruding from a free end of the arm to be lockable to the end edge of the holder, wherein the displacement limiting section includes a receiving surface, wherein the receiving surface is capable of coming into contact with the lock arm when the lock arm is displaced, and wherein the receiving surface extends obliquely to protrude closer to the lock arm in a direction of unlocking the lock protrusion from the end edge of the holder.

The invention according to claim 1 enables an unlocking event of the lock arm to be suppressed in the initial position even when the lever is brought into the initial position by the lock arm and an unintended external force is then applied to the lever.

### BRIEF DESCRIPTION OF THE DRAWINGS

FIG. 1 shows an exploded perspective view of a lever-operated connector according to an embodiment of the present invention;

FIG. 2 shows a perspective view illustrating a state in which a lever as part of the lever-operated connector is in a final locked position;

FIG. 3 shows a perspective view of the lever-operated connector illustrating a state in which the lever is in a temporary locked position (initial position);

FIG. 4 shows a view of the lever as viewed in a direction of an axis of rotation;

FIG. 5A shows the lever as viewed in the direction of arrow A in FIG. 4;

FIG. 5B shows an enlarged view of an essential part of FIG. 5A;

FIG. 6A shows the lever-operated connector illustrating a state in which the lever is in the temporary locked position;

FIG. 6B shows a front view of FIG. 6(A);

FIG. 7 shows an enlarged view of an essential part of FIG. 6B;

FIG. 8 shows a view for explanation of an effect of the lever-operated connector; and

FIG. 9 shows a front view of a conventional lever-operated connector 101.

### DETAILED DESCRIPTION OF THE PREFERRED EMBODIMENTS

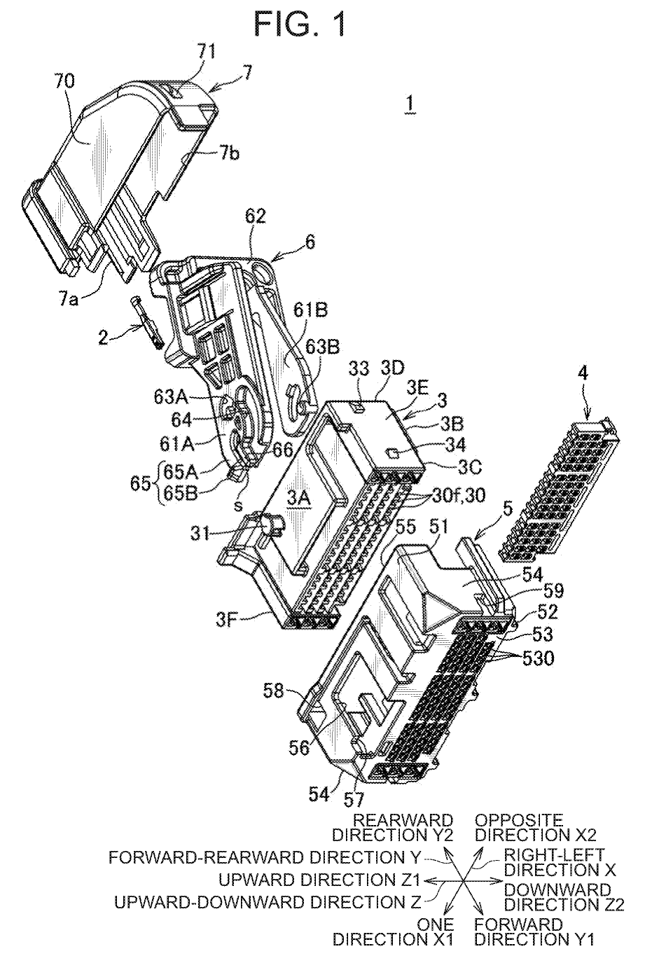

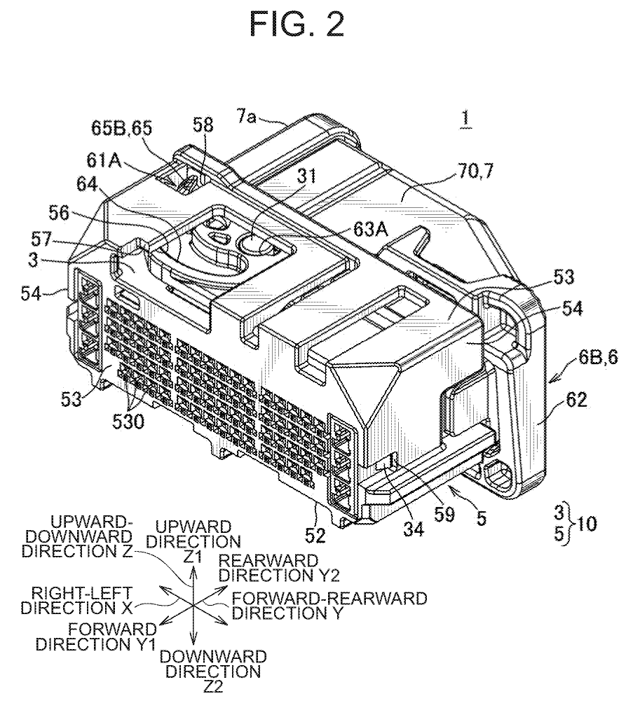

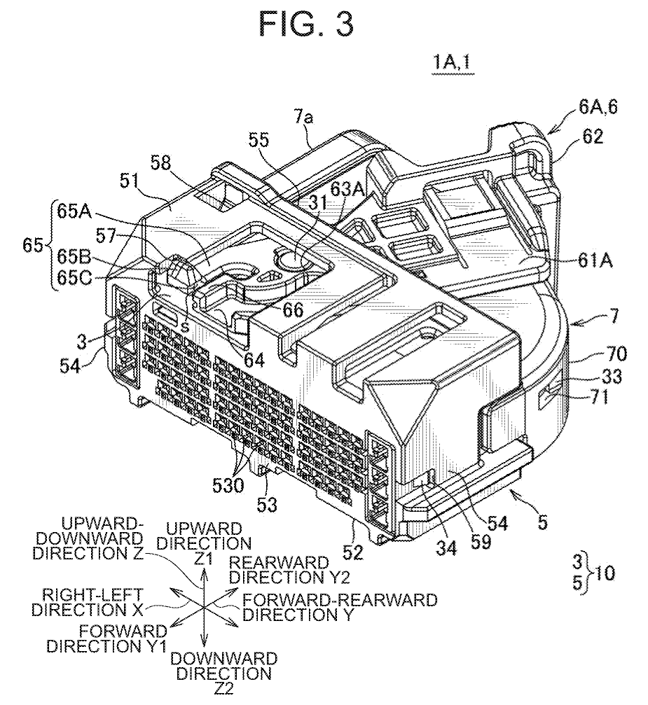

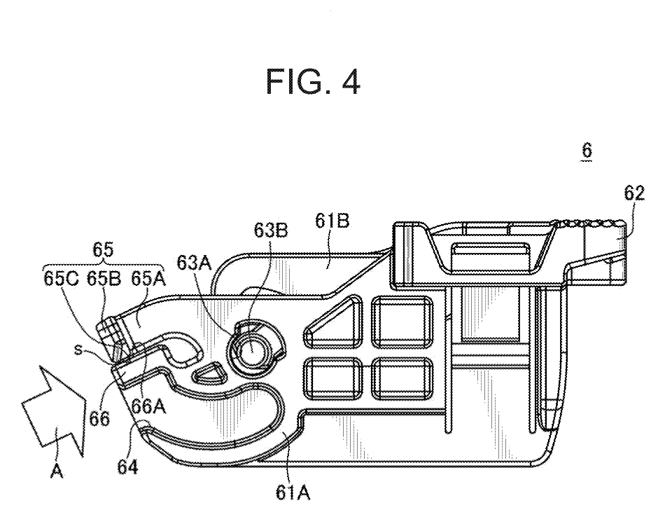

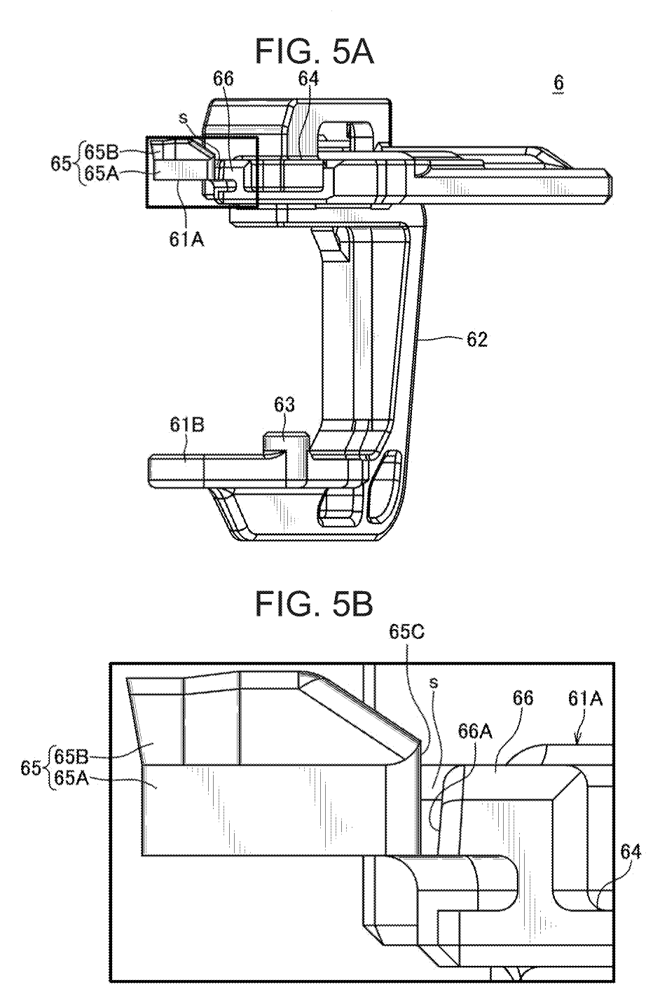

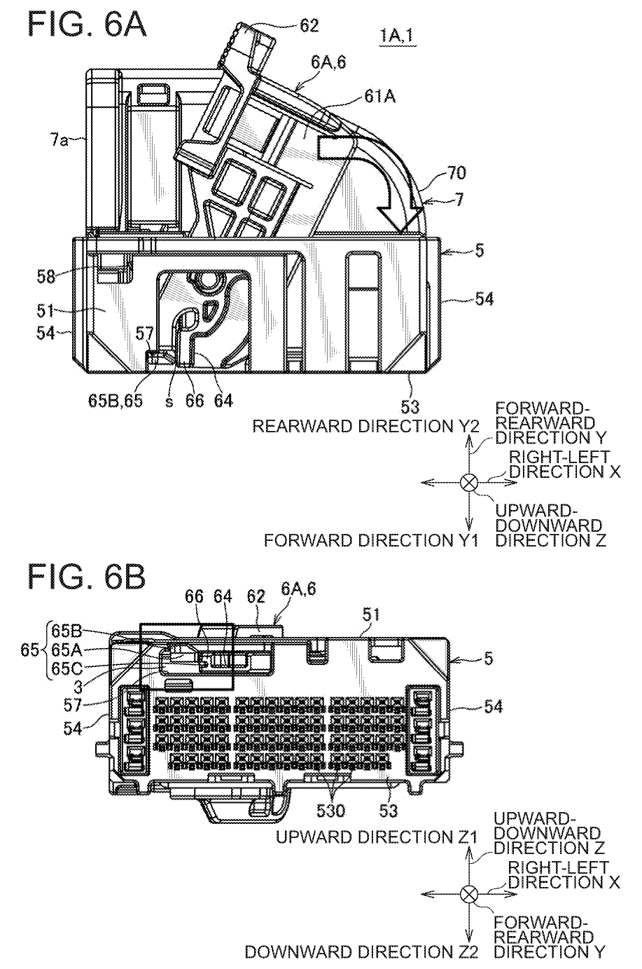

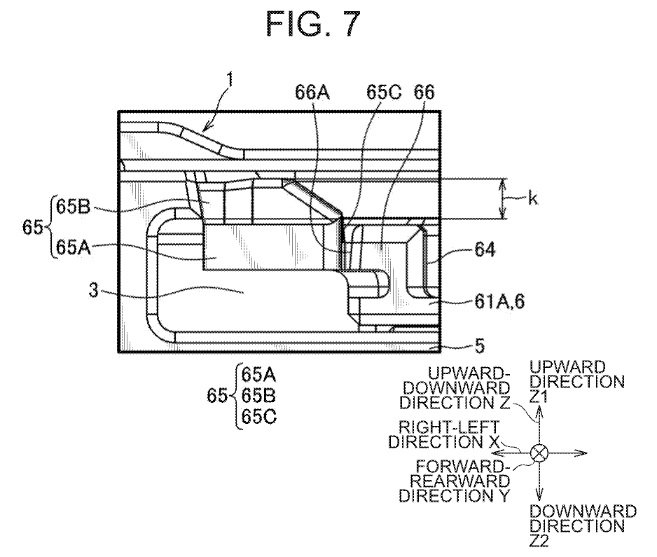

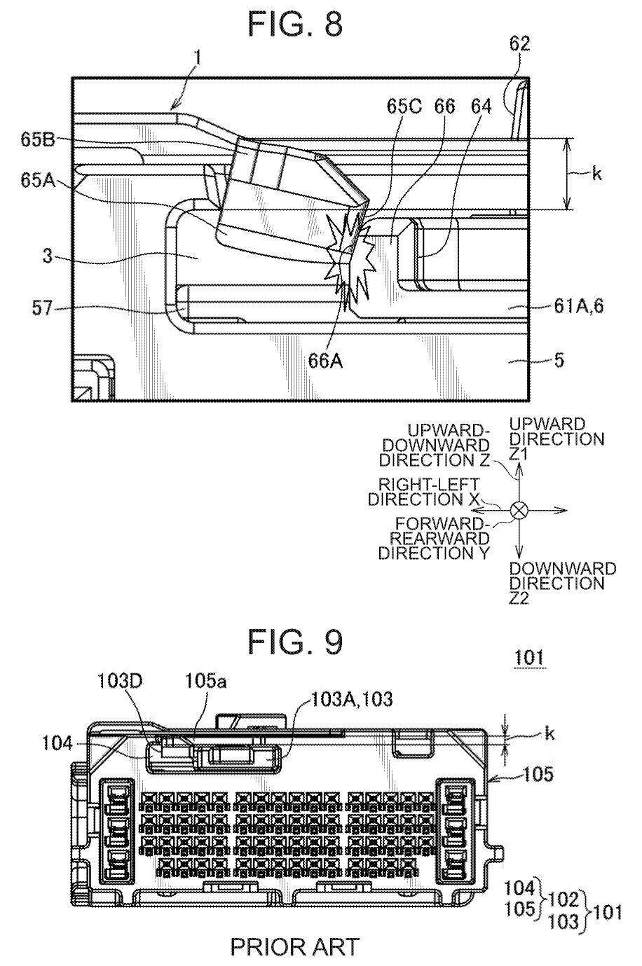

Hereinafter, a “lever-operated connector 1” according to an embodiment of the present invention will be described with reference to FIGS. 1 to 8. FIG. 1 shows an exploded perspective view of a lever-operated connector 1 according to an embodiment of the present invention. FIG. 2 shows a perspective view illustrating a state in which a lever 6 as part of the lever-operated connector 1 is in a final locked position. FIG. 3 shows a perspective view of the lever-operated connector 1 illustrating a state in which the lever 6 is in a temporary locked position (initial position). FIG. 4 shows a view of the lever 6 as viewed in a direction Z of an axis of rotation. FIG. 5A shows the lever 6 as viewed in the direction of arrow A in FIG. 4. FIG. 5B shows an enlarged view of an essential part of FIG. 5A. FIG. 6A shows the lever-operated connector 1 illustrating a state in which the lever 6 is in the temporary locked position. FIG. 6B shows a front view of FIG. 6(A). FIG. 7 shows an enlarged view of an essential part of FIG. 6B. FIG. 8 shows a view for explanation of an effect of the lever-operated connector 1.

The lever-operated connector 1 as shown in FIGS. 1 to 3 includes a connector main body 10, the lever 6, a displacement limiting section 66, and a cover 7. For example, the connector main body 10 includes a plurality of female terminals 2 (shown in FIG. 1), an inner housing 3 (housing) accommodating the plurality of female terminals 2, and a front mask 5 (holder) accommodating the inner housing 3. The lever 6 is pivotably mounted to the inner housing 3 and configured to be rotated between a final locked position 6B (shown in FIG. 2) and a temporary locked position 6A (initial position as shown in FIG. 3). The displacement limiting section 66 (shown in FIGS. 1 and 3) is provided at the lever 6 and configured to limit rotation (displacement) of the lever 6 due to an unintended external force applied to the lever 6. The cover 7 is configured to arrange electric wires therethrough which are connected to the plurality of female terminals 2.

FIG. 2 shows a state of the lever 6 which is positioned in the final locked position 6B while FIG. 3 shows a state of the lever 6 which is positioned in the temporary locked position 6A. The lever-operated connector 1 is configured in such a manner that the lever 6 is moved toward a partner connector (not shown) while the lever 6 is positioned in the temporary locked position (initial position), wherein the lever 6 is configured to be positioned in the final locked position 6B by rotating the lever 6 so that the lever-operated connector 1 is mated with the partner connector.

In the context of the present embodiment, arrow X, arrow Y and arrow Z shall extend orthogonally to each other. A direction of mating the lever-operated connector 1 with the partner connector (not shown) shall be defined as the direction Y (referred to as “forward-rearward direction Y”). A direction of an axis of rotation of the lever 6 shall be defined as the direction Z (referred to as “upward-downward direction Z”). A direction orthogonal to the direction Y and the direction Z shall be defined as the direction X (referred to as “right-left direction X”). A direction Y1 along the forward-rearward direction Y (pointing toward the partner connector for the lever-operated connector 1) may be indicated with “forward direction”, and an opposite direction Y2 along the forward-rearward direction Y may be indicated with “rearward direction”. A direction Z1 along the upward-downward direction Z (pointing toward a first arm plate 61A) may be indicated with “upward direction”, and an opposite direction Z2 along the upward-downward direction Z (pointing toward a second arm plate 61B) may be indicated with “downward direction”.

As shown in FIG. 1, the connector main body 10 includes the inner housing 3 accommodating the plurality of female terminals 2, a spacer 4, and the front mask 5. The spacer 4 is configured to be supported by the inner housing 3 and locked to the female terminals 2. The front mask 5 includes a temporary lock receiving portion 57 and a final lock receiving portion 58 which are configured to be locked to a lock arm 65 of the lever 6 which will be described below.

As shown in FIG. 1, the female terminals 2 connected to terminals of the electric wires (not shown) are accommodated in terminal accommodating chambers 30 of the inner housing 3, which will be described below. The electric wires connected to the female terminals 2 are drawn out of the respective terminal accommodating chambers 30 in the rearward direction Y2, wherein the electric wires are then inserted through an electric wire insertion opening 7a in the cover 7 – which will be described below – and drawn out in one direction along the right-left direction X.

The inner housing 3 is made of an insulating resin. As shown in FIG. 1, the inner housing 3 includes an upper surface 3A, a lower surface 3B, a front surface 3C, a rear surface 3D, right and left lateral surfaces 3E and 3F, the plurality of terminal accommodating chambers 30, and a spacer accommodating chamber (not shown), wherein the upper surface 3A and lower surface 3B extend along a XY-plane, and the front surface 3C, rear surface 3D and lateral surfaces 3E and 3F are continuous with the upper surface 3A and the lower surface 3B. A rotation shaft 31 is provided on each of the upper surface 3A and lower surface 3B to pivotably mount the lever 6 thereto. A spacer opening (not shown) is formed in the lower surface 3B to insert the spacer 4 therein, which will be described below. A cover lock receiving portion 33 and a mask lock receiving portion 34 are provided on each of the right and left lateral surfaces 3E and 3F, wherein the cover lock receiving portion 33 is configured to be locked to a housing lock portion 71 of the cover 7 as described below, and the mask lock receiving portion 34 is configured to be locked to a housing lock portion 59 of the front mask 5 as described below.

The plurality of terminal accommodating chambers 30 is arranged along the upward-downward direction Z and along the right-left direction X. Each of the terminal accommodating chambers 30 is formed in a quadrilateral-tubular shape and configured to accommodate a corresponding one of the female terminals 2. The quadrilateral-tubular shape has a direction of extension (direction of an axis of the tube) along the Y-direction.

Each of the terminal accommodating chambers 30 is opened in both of the forward direction Y1 and rearward direction Y2. One of the openings of each of the terminal accommodating chambers 30 which is oriented in the forward direction Y1 (which may be hereinafter referred to as “front opening 30f”) is provided for inserting one of partner terminals of the partner connector into the terminal accommodating chamber 30. An electric wire connected to each of the female terminals 2 is drawn out of the corresponding one of the terminal accommodating chambers 30 through one of the openings of each of the terminal accommodating chambers 30 which is oriented in the rearward direction Y2 (which may be hereinafter referred to as “rear opening”). Furthermore, a terminal lance (not shown) is provided on an inner surface of each of the terminal accommodating chambers 30 and configured to be locked to a corresponding one of the female terminals 2. The terminal lances and the spacer 4 (which will be described below) provide a double-lock effect of the female terminals 2 to limit removal of the female terminals 2 out of the respective terminal accommodating chambers 30.

The spacer accommodating chamber is formed by part of the terminal accommodating chambers 30 and configured to accommodate the spacer 4 as described below.

Each of the rotation shafts 31 is provided on one of the upper surface 3A and the lower surface 3B and is configured to be inserted through a corresponding one of bearings 63A and 63B of the lever 6 to pivotably mount the lever 6.

The spacer 4 is configured to be inserted into the spacer opening formed in the lower surface 3B of the inner housing 3 to be accommodated into the spacer accommodating chamber. The spacer 4 is configured to be displaceable between the temporary locked position and the final locked position. While the spacer 4 is in the temporary locked position, the female terminals 2 are inserted in to the respective terminal accommodating chambers 30 to engage the female terminals 2 with the respective lances so that primary lock of the female terminals 2 is provided. This spacer 4 is displaced from the temporary locked position to the final locked position to engage the female terminals 2 with the spacer 4 so that secondary lock of the female terminals 2 is provided.

The front mask 5 is made of an insulating resin. As shown in FIG. 1, the front mask 5 includes an upper wall 51, a lower wall 52, a front wall 53, right and left lateral walls 54, 54, an exposure opening 56, a temporary lock receiving portion 57 (end edge), and a final lock receiving portion 58, wherein the upper wall 51 and lower wall 52 extend along a XY-plane, and the front wall 53 and lateral walls 54, 54 are continuous with the upper wall 51 and the lower wall 52. The exposure opening 56 is formed in a box shape which includes an accommodation opening 55 for receiving the inner housing 3, wherein the exposure opening 56 is configured to expose a forward end side of the lever 6 as described below. The temporary lock receiving portion 57 is defined at a peripheral edge of the exposure opening 56 and configured to be locked to the lock arm 65 on the lever 6 in the temporary locked position 6A. The final lock receiving portion 58 is configured to be locked to the lock arm 65 in the final locked position 6B.

The front wall 53 has communication holes 530, wherein each of the communication holes 530 is formed in a position of the front wall 53 in which the communication hole 530 is in communication with a front opening 30f of a corresponding one of the terminal accommodating chambers 30 in the inner housing 3. A housing lock portion 59 is provided on each of the right and left lateral walls 54, 54 and configured to be locked to a corresponding one of the mask lock receiving portions 34 of the inner housing 3.

The exposure opening 56 is formed by cutting out part of the upper wall 51 and front wall 53 to expose the lock arm 65 and an entrance opening of a cam groove 64 of the lever 6 which will be described below. The temporary lock receiving portion 57 is defined at the peripheral edge of the exposure opening 56, wherein the temporary lock receiving portion 57 is configured to be locked to the lock arm 65 of the lever 6.

The temporary lock receiving portion 57 is arranged farther in the rear direction Y2 than a front end of the front mask 5 and formed to include a plane spanning along the right-left direction X and along the upward-downward direction Z.

The final lock receiving portion 58 is arranged at one end of the front mask 5 oriented in the right-left direction X and at a rear end of the front mask 5. The final lock receiving portion 58 is defined at a peripheral edge of a rectangular opening of the front mask 5 which allows the lock arm 65 of the lever 6 to be exposed, which will be described below.

The lever 6 is made of an insulating resin. As shown in FIG. 4, the lever 6 includes a first arm plate 61A (lever main body), a second arm plate 61B (the other of a pair of arm plates), and a connecting portion 62 connecting the first arm plate 61A to the second arm plate 61B, wherein the first arm plate 61A and the second arm plate 61B are opposed to each other and the inner housing 3 is interposed therebetween. In this manner, the lever 6 is formed in the form of a gate (C-shape).

The first arm plate 61A extends along the XY-plane (i.e., in the same direction as the upper surface 3A of the inner housing 3 and the upper wall 51 of the front mask 5) and thus has a plate shape.

The first arm plate 61A includes the bearing 63A, the cam groove 64, the lock arm 65 configured to be locked to the front mask 5, and the displacement limiting section 66, wherein the bearing 63A is configured to be mated with the rotation shaft 31 of the inner housing 3 and the cam groove 64 is configured for inserting a guide protrusion of the partner connector therethrough. The displacement limiting section 66 is configured to limit rotation (displacement) of the lever 6 due to an unintended external force applied to the lever 6.

The first bearing 63A is formed in a through-hole shape and configured for inserting the rotation shaft 31 of the inner housing 3 therethrough. In this manner, the lever 6 is pivotably mounted to be rotatable relative to the inner housing 3 around the rotation shaft 31 and the bearing 63A (63B). It is to be noted that the bearing 63A may not be formed in a through-hole shape, but in a recess shape in an inner surface of the first arm plate 61A. Furthermore, the bearing 63A of the first arm plate 61A may be formed in a protrusion shape, wherein the rotation shaft 31 of the inner housing 3 may be formed in a through-hole shape or a recess shape.

The cam groove 64 is formed in the form of a slit in the first arm plate 61A, wherein the slit has a cross-section with a recess shape. The cam groove 64 has a shape (trajectory) which allows the guide protrusion of the partner connector to be inserted therethrough, wherein the shape (trajectory) of the cam groove 64 is further configured to move the guide protrusion toward the first bearing 63A when rotating the lever 6. The partner connector is moved toward the connector main body 10 by rotating the lever 6 and moving the guide protrusion of the partner connector within the cam groove 64 so that the lock arm 65 is locked to the final lock receiving portion 58 and the partner connector and the connector main body 10 are thus in a mated state with each other.

As shown in FIGS. 4 and 5, the lock arm 65 is provided at an end of the first arm plate 61A facing away from the connecting portion 62 and adjacent to a wall defining the entrance opening of the cam groove 64 (this wall may be hereinafter referred to as “displacement limiting section 66”) via the slit S. This means that the lock arm 65 and the displacement limiting section 66 are arranged in positions which are adjacent to each other via the slit S.

As shown in FIGS. 5A and 5B, the lock arm 65 includes a cantilevered arm 65A, a lock protrusion 65B, and a contact surface 65C, wherein the arm 65A is bendable in the upward-downward direction Z, and the lock protrusion 65B protrudes in the upward direction Z1 from a free end of the arm 65A (in a direction pointing away from the second arm plate 61B). The contact surface 65C is provided at the arm 65A and capable of coming into contact with a receiving surface 66A of the displacement limiting section 66 which will be described below.

As shown in FIG. 1, the arm 65A is formed by forming the slit S in the first arm plate 61A. The slit S is formed by cutting out part of an end edge of the first arm plate 61A facing away from the connecting portion 62. The slit S further extends rectilinearly toward the connecting portion 62.

As shown in FIGS. 5A and 5B, the displacement limiting section 66 is a lateral wall defining the entrance opening of the cam groove 64. The displacement limiting section 66 includes the receiving surface 66A (shown in FIG. 5B) configured to come into contact with the contact surface 65C of the lock arm 65 when the lock arm 65 is displaced.

As shown in FIG. 5B, the receiving surface 66A is provided in a position facing the contact surface 65C of the lock arm 65. The receiving surface 66A further includes an oblique surface which protrudes closer to the lock arm 65 in the downward direction Z2 (direction of unlocking the lock arm 65).

When an unintended external force is applied to the lever 6 in the temporary locked position 6A, such a receiving surface 66A is moved toward the lock arm 65 to come into contact with the contact surface 65C of the lock arm 65 so that displacement of the lock arm 65 in the downward direction Z2 is limited by the oblique surface of the receiving surface 66A, as shown in FIG. 8. With such a receiving surface 66A, displacement of the lock arm 65 is limited to ensure an engaged margin k so that the lock arm 65 is maintained in a locked state in which it is locked to the temporary lock receiving portion 57.

As shown in FIG. 1, the second arm plate 61B includes a second bearing 63B configured to be mated with the rotation shaft 31 of the inner housing 3.

The cover 7 is made of an insulating resin. As shown e.g. in FIGS. 1 and 2, the cover 7 includes a cover main body 70 and the housing lock portion 71 provided on the cover main body 70, wherein the cover main body 70 includes the electric wire insertion opening 7a and an attachment opening 7b for attaching the cover 7 to the inner housing 3 and configured to cover a face of the inner housing 3 oriented in the rear direction Y2. The housing lock portion 71 is configured to be locked to the cover lock receiving portion 33 of the inner housing 3.

Next, a procedure for assembling the lever-operated connector 1 will be described with reference to FIGS. 6A, 6B and 7.

First, the inner housing 3 is moved toward a region between the first arm plate 61A and the second arm plate 61B of the lever 6 to interpose the inner housing 3 between the first arm plate 61A and the second arm plate 61B. In this manner, the bearings 63A and 63B are pivotably mounted to the respective rotation shafts 31, wherein the lever 6 is pivotably mounted to the inner housing 3 in a rotatable manner. In this manner, an assembled inner housing 3 with the lever 6 is obtained.

Subsequently, the inner housing 3 with the lever 6 is moved toward the accommodation opening 55 of the front mask 5 and inserted into the accommodation opening 55. In this manner, the front opening 30f of each of the terminal accommodating chambers 30 in the inner housing 3 is now in communication with the corresponding one of the communication holes 530, wherein the mask lock receiving portions 34 of the inner housing 3 are locked to the respective housing lock portions 59 of the front mask 5. Furthermore, the lever 6 is positioned in the final locked position 6B in which the lock protrusion 65B is locked to the final lock receiving portion 58 of the front mask 5. In this manner, the inner housing 3 with the lever 6 is accommodated in the front mask 5.

Subsequently, the spacer 4 is positioned in a temporary locked position of the inner housing 3, wherein the female terminals 2 connected to the electric wires are inserted into the terminal accommodating chambers 30 of the inner housing 3 through the rear opening in the forward direction Y1. In this manner, the female terminals 2 are locked to the terminal lances. Subsequently, the spacer 4 is displaced from the temporary locked position to a final locked position. In this manner, a double-lock effect of each of the female terminals 2 is provided by the terminal lances and the spacer 4 to limit removal of the female terminals 2 out of the respective terminal accommodating chambers 30. During this process, the electric wires connected to the female terminals 2 are drawn out of the inner housing 3.

Subsequently, the attachment opening 7b of the cover 7 is moved toward the inner housing 3 with the lever 6, wherein the electric wires drawn out of the inner housing 3 are inserted through the electric wire insertion opening 7a of the cover 7. In this manner, the cover lock receiving portions 33 are locked by the respective housing lock portions 71. Thus, the cover 7 is assembled with the inner housing 3 with the lever 6. During this process, the electric wires drawn out of the inner housing 3 extend out in one direction along the right-left direction X.

Subsequently, the lever 6 is rotated from the final locked position 6B to the temporary locked position 6A. The lock arm 65 of the lever 6 is unlocked from the final lock receiving portion 58 of the front mask 5 so that the lever 6 is now in a rotatable state. Further rotation of the lever 6 locks the lock arm 65 to the temporary lock receiving portion 57 of the front mask 5, as shown in FIG. 2 (see FIGS. 6A and 6B).

In this state, rotation of the lever 6 is limited by locking the lock arm 65 to the temporary lock receiving portion 57. At this time, the lock arm 65 is in a natural state in which it is not elastically deformed, wherein the lock arm 65 includes a predetermined engaged margin k with which the lock arm 65 is locked to the temporary lock receiving portion 57, as shown in FIG. 7.

In this manner, the lever 6 is positioned in the temporary locked position 6A (initial position) so that the lever-operated connector 1 is in a shipped configuration. In this manner, the assembly of the lever-operated connector 1 is completed. This lever-operated connector 1 is shipped with the lever 6 being in the temporary locked position 6A.

Here, when the lever 6 of the lever-operated connector 1A(1) is in the temporary locked position 6A (initial position) as shown in FIGS. 6A, 6B and 7, the receiving surface 66A of the displacement limiting section 66 is moved toward the lock arm 65 even in the event of an unintended external force acting on the lever 6 as shown in FIG. 8, and then comes into contact with the contact surface 65C of the lock arm 65, for example during transportation, wherein the oblique receiving surface 66A results in limitation of displacement of the lock arm 65 in the downward direction Z2 so that the displacement of the lock arm 65 is stopped. With such a receiving surface 66A, displacement of the lock arm 65 is limited to ensure the engaged margin k so that the lock arm 65 is maintained in a locked state in which it is locked to the temporary lock receiving portion 57.

According to the above-described embodiment, the displacement limiting section 66 includes the receiving surface 66A, wherein the receiving surface 66A is capable of coming into contact with the lock arm 65 when the lock arm 65 is displaced, and wherein the receiving surface 66A extends obliquely to protrude closer to the lock arm 65 in the downward direction Z2 (direction of unlocking the lock protrusion 65B from the temporary lock receiving portion 57). Even in the event of an unintended external force acting on the lever 6 of the lever-operated connector 1 while the lock arm 65 of the lever 6 is locked to the temporary lock receiving portion 57, the lock arm 65 comes into contact with the receiving surface 66A of the displacement limiting section 66 so that displacement of the lock arm 65 in the downward direction Z2 is limited by the oblique receiving surface 66A, which enables an unlocking event of the lock arm 65 from the temporary lock receiving portion 57 to be suppressed.

Although the best configuration, method etc. for implementing the present invention are disclosed in the above description, the present invention is not limited thereto. Namely, while the present invention is particularly shown and described mainly with regard to the specific embodiments, the above mentioned embodiments may be modified in various manners in shape, material characteristics, amount or other detailed features by those skilled in the art without departing from the scope of the technical idea and purpose of the present invention. Therefore, the description with limited shapes, material characteristics etc. according to the above disclosure is not limiting the present invention, but merely illustrative for easier understanding the present invention so that the description using names of the elements without a part or all of the limitations to their shapes, material characteristics etc. is also included in the present invention.

### REFERENCE SIGNS LIST

1 Lever-operated connector

3 Inner housing (housing)

5 Front mask (holder)

57 Temporary lock receiving portion (end edge)

6 Lever

61A First arm plate (lever main body)

65 Lock arm

65A Arm

65B Lock protrusion

66 Displacement limiting section

66A Receiving surface

What is claimed is:

1. A lever-operated connector comprising:
a housing;
a holder configured to accommodate the housing; and
a lever pivotably mounted to the housing and configured to be rotated by the housing,
wherein the lever includes:
a lever main body having a plate shape and configured to be inserted between the housing and the holder;
a lock arm provided at the lever main body to be lockable to an end edge of the holder; and
a displacement limiting section configured to limit displacement of the lock arm,
wherein the lock arm includes:
an arm cut out from the lever main body; and
a lock protrusion protruding from a free end of the arm to be lockable to the end edge of the holder,
wherein the displacement limiting section includes a receiving surface,
wherein the receiving surface is capable of coming into contact with the lock arm when the lock arm is displaced, and
wherein the receiving surface extends obliquely to protrude closer to the lock arm in a direction of unlocking the lock protrusion from the end edge of the holder.
